(19) United States
(12) Patent Application Publication
(10) Pub. No.: US 2026/0116705 A1
(43) Pub. Date: Apr. 30, 2026

(54) ACTIVE DYNAMIC BRAKING SOLUTION FOR AN ELEVATOR SYSTEM

(71) Applicant: Kone Corporation, Helsinki (FI)

(72) Inventors: Teppo VUORIO, Helsinki (FI); Lauri STOLT, Helsinki (FI); Juhamatti NIKANDER, Helsinki (FI)

(73) Assignee: Kone Corporation, Helsinki (FI)

(21) Appl. No.: 19/330,381

(22) Filed: Sep. 16, 2025

(30) Foreign Application Priority Data
Oct. 31, 2024 (EP) 24210011.3

(51) Int. Cl. B66B 5/06

(52) U.S. Cl. CPC B66B 5/06

(57) ABSTRACT

The invention relates to a method for active dynamic braking of an elevator system. The method comprising: detecting a dynamic braking situation, obtaining speed data representing a speed of an elevator car, and activating an active dynamic braking operation for dynamically braking the movement of the elevator car, if the obtained speed data indicates that the speed of the elevator car reaches a predetermined monitoring speed level. The active dynamic braking operation comprises operating a motor inverter of an elevator drive unit of the elevator system by switching high-side switches and low-side switches of the motor inverter in a controlled manner so that a rotating field is generated in stator windings of a hoisting motor for dynamically braking the rotation of the hoisting motor and thus the movement of the elevator car. The invention relates also to an elevator drive unit, an elevator system, a computer program, and a computer-readable storage medium.

### CROSS-REFERENCE TO RELATED APPLICATIONS

This application claims priority to European Patent Application No. EP24210011.3 filed on Oct. 31, 2024, the entire contents of which are incorporated herein by reference.

### TECHNICAL FIELD

The invention concerns in general the technical field of elevator systems. Especially the invention concerns an active dynamic braking solution for elevator systems.

### BACKGROUND

Sometimes in elevator systems a hoisting motor of the elevator system is used to generate braking torque outside of a normal operation of the elevator system to perform a braking operation to brake the movement of an elevator car. This braking operation may be needed, for example, when an elevator car having passenger inside it has been stopped between floors due to a power failure. In that case, typically a field technician comes to the elevator site and opens hoisting machine brakes manually to allow the movement of the elevator car by means of gravity. Another case, in which said braking operation may be needed, can occur, if braking force of elevator hoisting machine brakes has been compromised for some reason. For example, an error in conducting an elevator maintenance, such as a misconduct in a brake adjustment process may lead to such a situation, or if foreign matter, such as oil or grease, gets into the braking surfaces.

Traditionally, in case of permanent magnet motors said braking operation has been implemented by shorting stator windings of the hoisting motor, such that rotation of the hoisting motor causes electro motive force (EMF) voltage in the windings of the hoisting motor. The short-circuit in turn causes a current flow in the windings creating a motor torque that acts against the rotation of the hoisting motor, and thus brakes the movement of the elevator car. This braking operation is referred to as dynamic braking. The problem with this traditional dynamic braking operation is that it does not necessarily work properly with all various hoisting motor models and with all various load combinations. With some hoisting motor and/or load combinations, the braking torque may not be adequate, and the elevator operation would become unstable (i.e. the elevator races).

Consequently, there is a need for an improved dynamic braking, which generates sufficient amount of motor torque with various hoisting motor and/or load combinations, irrespective of the operational condition and environment of the elevator system.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, an elevator drive unit, an elevator system, a computer program, and a computer-readable storage medium for active dynamic braking of an elevator system. Another objective of the invention is that the method, the elevator drive unit, the elevator system, the computer program, and the computer-readable storage medium for active dynamic braking of an elevator system enable ensuring that a hoisting motor generates enough power to maintain the active dynamic braking operation to dynamically braking the movement of the elevator car.

The objectives of the invention are reached by a method, an elevator drive unit, an elevator system, a computer program, and a computer-readable storage medium as defined by the respective independent claims.

According to a first aspect, a method for active dynamic braking of an elevator system is provided, wherein the method comprises: detecting a dynamic braking situation; obtaining speed data representing a speed of an elevator car, and activating an active dynamic braking operation for dynamically braking the movement of the elevator car, if the obtained speed data indicates that the speed of the elevator car reaches a predetermined monitoring speed level; wherein the active dynamic braking operation comprises operating a motor inverter of an elevator drive unit of the elevator system by switching high-side switches and low-side switches of the motor inverter in a controlled manner so that a rotating field is generated in stator windings of a hoisting motor for dynamically braking the rotation of the hoisting motor and thus the movement of the elevator car.

The method may further comprise adjusting a braking torque generated by the hoisting motor so that the speed of the elevator car does not at least exceed an adaptive speed limit value during the active dynamic braking operation, wherein the predetermined monitoring speed level may be lower than the adaptive speed limit value.

The method may further comprise: monitoring adequacy of a supply voltage of the elevator drive unit to energize the elevator drive unit, wherein the supply voltage of the elevator drive unit may be regenerated from the hoisting motor; and increasing the adaptive speed limit value, if the monitoring of the adequacy of the supply voltage of the elevator drive unit indicates that the present level of the adaptive speed limit value is not adequate to energize the elevator drive unit.

The monitoring of the adequacy of the supply voltage of the elevator drive unit may comprise monitoring at least one of the following: adequacy of the regenerated motor power, and wherein the adaptive speed limit value may be increased, if regenerated motor power drops below a minimum power limit; a DC link voltage of the drive unit, and wherein the adaptive speed limit value may be increased, if the DC link voltage of the drive unit drops below a minimum voltage limit; a magnetization-axis current of the hoisting motor, and wherein the adaptive speed limit value may be increased, if the magnetization-axis current falls below a minimum current limit.

The adjusting of the braking torque generated by the hoisting motor may comprise operating the high-side switches and the low-side switches of the motor inverter.

The dynamic braking situation may be one of the following: a manual opening of a hoisting machine brake due to a power failure situation; an inadequate braking force situation upon issuing a hoisting machine brake activation command.

According to a second aspect, an elevator drive unit of an elevator system is provided, wherein the elevator drive unit comprises: a motor inverter connected to stator windings of a hoisting motor of the elevator system, wherein the motor inverter has high-side switches and low-side switches; and a drive controller; wherein the drive controller of the elevator drive unit is configured to cause the elevator drive unit to perform: detect a dynamic braking situation; obtain speed data representing a speed of an elevator car; and activate an active dynamic braking operation for dynamically braking the movement of the elevator car, if the obtained speed data indicates that the speed of the elevator car reaches a predetermined monitoring speed level; wherein the active dynamic braking operation comprises that the drive controller is configured to operate the motor inverter by switching the high-side switches and the low-side switches of the motor inverter in a controlled manner so that the rotating field is generated in the stator windings of the hoisting motor for dynamically braking the rotation of the hoisting motor and thus the movement of the elevator car.

The elevator drive unit may further be configured to adjust a braking torque generated by the hoisting motor so that the speed of the elevator car does not at least exceed an adaptive speed limit value during the active dynamic braking operation, wherein the predetermined monitoring speed level may be lower than the adaptive speed limit value.

The elevator drive unit is further configured to: monitor adequacy of a supply voltage of the elevator drive unit to energize the elevator drive unit, wherein the supply voltage of the elevator drive unit may be regenerated from the hoisting motor; and increase the adaptive speed limit value, if the monitoring of the adequacy of the supply voltage of the elevator drive unit indicates that the present level of the adaptive speed limit value is not adequate to energize the elevator drive unit.

To monitor the adequacy of the supply voltage of the elevator drive unit, the elevator drive unit may be configured to monitor at least one of the following: adequacy of the regenerated motor power, and wherein the elevator drive unit may be configured to increase the adaptive speed limit value, if the regenerated motor power drops below a minimum power limit; a DC link voltage of the drive unit, and wherein the elevator drive unit may be configured to increase the adaptive speed limit value, if the DC link voltage of the drive unit drops below a minimum voltage limit; a magnetization-axis current of the hoisting motor, and wherein the elevator drive unit may be configured to increase the adaptive speed limit value, if the magnetization-axis current falls below a minimum current limit.

The elevator drive unit may be configured to operate the high-side switches and low-side switches of the motor inverter to adjust the braking torque.

The dynamic braking situation may be one of the following: a manual opening of a hoisting machine brake due to a power failure situation; an inadequate braking force situation upon issuing a hoisting machine brake activation command.

According to a third aspect, an elevator system is provided, wherein the elevator system comprises: an elevator hoisting machine comprising a hoisting motor, an elevator car configured to travel along an elevator shaft, an elevator car speed measurement system configured to provide speed data representing a speed of the elevator car, and an elevator drive unit as described above.

According to a fourth aspect, a computer program is provide, wherein the computer program comprises instructions which, when the program is executed by a computer, cause the computer to carry out the method described above.

According to a fifth aspect, a computer-readable storage medium is provided, wherein the computer-readable storage medium comprises instructions which, when executed by a computer, cause the computer to carry out the method discussed above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2A illustrates schematically a simple example of an elevator drive unit connected to a hoisting motor.

FIG. 2B illustrates schematically a simple example of a frequency converter.

FIG. 2C illustrates schematically an example circuit diagram of a motor inverter.

FIG. 3 illustrates schematically an example of a method for active dynamic braking of the elevator system.

FIG. 4 illustrates schematically another example of the method.

FIG. 5 illustrates a schematic example of components of a drive controller of the elevator drive unit.

### DESCRIPTION OF THE EXEMPLIFYING EMBODIMENTS

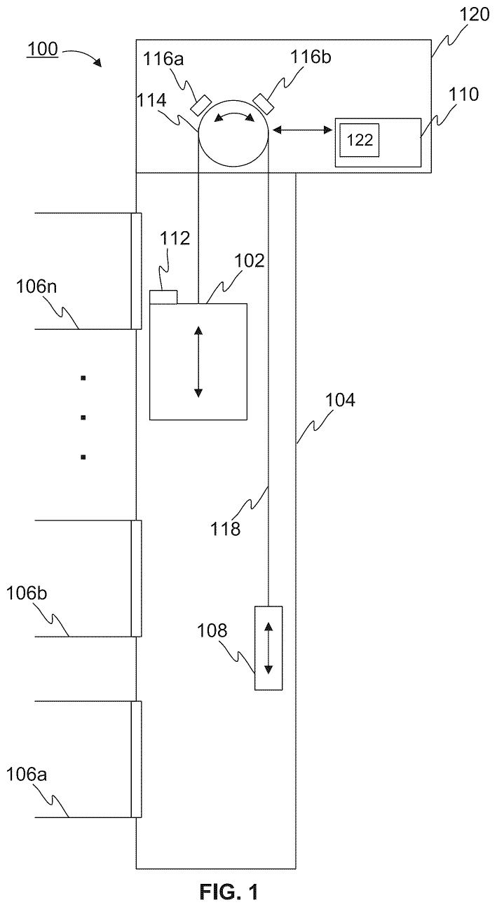

FIG. 1 illustrates schematically an example of an elevator system 100. The elevator system 100 comprises an elevator car 102 configured to travel along an elevator shaft 104 between a plurality of floors (i.e. landings) 106a-106n, a counterweight 108, an elevator hoisting machine, an elevator control unit 110, and an elevator car speed measurement system 112. The elevator system 100 may also form an elevator group, i.e. group of two or more elevator cars 102 each travelling along a separate elevator shaft 104 configured to operate as a unit serving the same landings 106a-106n. The elevator system 100 may further comprise one or more known elevator related entities, e.g. user interface devices, elevator doors, and/or safety circuit and devices, etc., which are not shown in FIG. 1 for sake of clarity.

The elevator hoisting machine is configured to drive the elevator car 102 along the elevator shaft 104 between the floors 106a-106n. The elevator hoisting machine comprises a hoisting motor (e.g. an electric motor such as a permanent magnet motor) 230 and a traction sheave 114 for lifting the elevator car 102. The elevator hoisting machine further comprises a hoisting machine brake arrangement comprising at least two hoisting machine brakes 116a, 116b directly effecting to the traction sheave 114 to stop unintended motion of the elevator car 102. In the example of FIG. 1, the elevator hoisting machinery brake arrangement comprises two hoisting machine brakes 116a, 116. However, the hoisting machine brake arrangement may also comprise more than two hoisting machine brakes. For illustrative purposes, only the traction sheave 114 and the hoisting machine brakes 116a, 116b of the elevator hoisting machine are shown in FIG. 1.

The elevator car 102, the elevator hoisting machine, and the counterweight 108 are interconnected via a hoisting roping arrangement 118 routed via the traction sheave 114 and a plurality of pulleys, which are not shown in FIG. 1 for sake of clarity. When the traction sheave 114 rotates, the elevator car 102 and the counterweight 108 are moving. The hoisting roping arrangement 118 comprises at least one hoisting rope or belt.

The elevator control unit 110 is configured to at least control the operations of the elevator system 100. The elevator control unit 110 may locate inside a machine room 120 (as illustrated in the example of FIG. 1) or at one of the floors 106a-106n, e.g. in a machine roomless elevator system. The elevator control unit 110 is communicatively coupled to the other entities of the elevator system 100. The communication between the elevator control unit 110 and the other entities of the elevator system 100 may be based on one or more known communication technologies, either wired or wireless. The implementation of the elevator control unit 110 may be done as a stand-alone control entity or as a distributed control environment between a plurality of stand-alone control entities, such as a plurality of servers, providing distributed control resource. The elevator control unit 110 comprises an elevator drive unit 122 for controlling the hoisting motor 230 (e.g. power feed to the hoisting motor and speed and/or torque of the hoisting motor) in order to move the elevator car 102 along the elevator shaft 104.

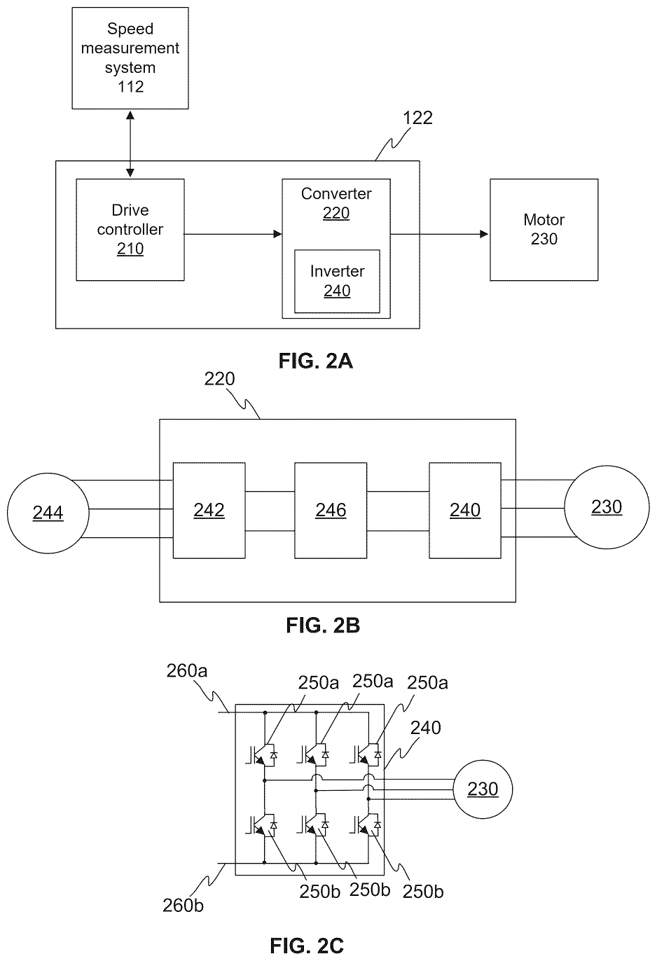

The elevator drive unit 122 comprises a drive controller 210 and a frequency converter 220. FIG. 2A illustrates schematically a simple example of the elevator drive unit 122 connected to the hoisting motor 230. The drive controller 210 may for example be a digital signal processor (DSP). The drive controller 210 is configured to generate, i.e. define, a speed reference of the hoisting motor 230 and a torque reference of the hoisting motor 230. The speed reference represents the speed of the hoisting motor 230 as a function of time. The torque reference represents the torque of the hoisting motor 230 as a function of time. The drive controller 210 is configured to provide the generated speed and torque references to the frequency converter 220. The frequency converter 220 is configured to control the speed and the torque of the hoisting motor 230 according to the speed and torque references.

FIG. 2B illustrates schematically a simple example of the frequency converter 220 of the elevator drive unit 122. The frequency converter 220 comprises a motor inverter, i.e. an inverter bridge, 240. The motor inverter 240 is connected to stator windings of the hoisting motor 230. The frequency converter 220 further comprises a rectifier, i.e. a rectifier bridge, 242 connected to mains 244. The motor inverter 240 is connected to the rectifier 242 via a DC link 246. The DC link 246 may comprise for example a capacitor or a set of capacitors connected in parallel with a high voltage busbar 260a and a low voltage busbar 260b. The motor inverter 240 has high-side switches 250a and low-side switches 250b. The drive controller 210 is configured to generate a rotating field in the stator windings of the hoisting motor 230 by switching the high-side switches 250a and low-side switches 250b of the motor inverter 240. Said rotating field causes the rotation of the traction sheave 114. The friction between the traction sheave 114 and the hoisting roping arrangement 118 has the effect, that elevator car 102 moves when the traction sheave 114 rotates.

FIG. 2C illustrates schematically an example circuit diagram of the motor inverter 240. The high-side switches 250a and the low-side switches 250b of the motor inverter 240 form the inverter bridge. In the example of FIG. 2B, each high-side switch 250a and each low-side switch 250b of the motor inverter 240 comprises a semiconductor switch, which is connected in parallel with an antiparallel diode. The semiconductor switch may for example be an Insulated-gate bipolar transistors (IGBT) or a metal-oxide-semiconductor field-effect transistor (MOSFET), a Gallium Nitride (GaN)-transistor, or a Silicon Carbide (SiC)-transistor. The high-side switches 250a are connected to the high voltage busbar 260a of the DC link 246 and the low-side switches 250b are connected to the low voltage busbar 260b of the DC link 246. The high-side switches 250a and the low-side switches 250b are connected between the two busbars 260a, 260b of the DC link 246 on one hand and to the feed line of the hoisting motor 230 on the other hand, which is a three-phase feed line according to a standard three-phase elevator motor, which is preferably a permanent magnet motor.

The elevator car speed measurement system 112 is configured to provide speed data representing a speed of the elevator car 102. The elevator speed measurement system may comprise a motor encoder, which indicates rotating speed of the hoisting motor 230. Additionally or alternatively, the elevator speed measurement system 112 may comprise a sensor providing a direct indication of the speed of the elevator car 102. The sensor providing the direct indication may for example be, but is not limited to, an acceleration sensor attached to the elevator car 102, an encoder mounted to a rope pulley of the elevator car 102, or a measurement device attached to the elevator car 102 and adapted to measure target(s) attached to fixed structure(s) in the elevator shaft 104. In the example of FIG. 1, the elevator car speed measurement system 112 is implemented with a measurement device attached to the elevator car 102, but this is only one example implementation of the elevator car speed measurement system 112 as discussed.

During a normal elevator operation, the movement of the elevator car 102 follows a desired elevator drive profile such that the elevator car 102 leaves smoothly from a departure floor, accelerates to a maximum speed (i.e. a rated speed), and further decelerates from the rated speed such that elevator car 102 arrives smoothly at a destination floor. When the elevator car 102 arrives at a destination floor, the elevator control unit 110 executes a stop operation to stop the movement of the elevator car 102 and to hold the elevator car 102 standstill in the elevator shaft 104 by activating the hoisting machine brake(s) 116. The normal elevator operation may further comprise for example an inspection operation. In the inspection operation, the elevator car 102 moves along the elevator shaft 104 with a low speed in accordance with manual drive commands issued by a service technician. Outside the normal elevator operation there may exist situations where dynamic braking of the movement of the elevator car 102 may be needed. An active dynamic braking operation discussed next may be used for the dynamically braking the movement of the elevator car 102 in such situations.

Next an example of a method for active dynamic braking of an elevator system 100 is described by referring to FIG. 3, which illustrates schematically the method as a flow chart. The method is performed by the elevator drive unit 122.

At step 310, the elevator drive unit 122 detects a dynamic braking situation. The dynamic braking situation may be a situation outside the normal elevator operation, in which the active dynamic braking is to be used. The dynamic braking situation may for example be at least one of the following: a manual opening of the hoisting machine brake(s) 116 due to a power failure situation; an inadequate braking force situation upon issuing a hoisting machine brake activation command. The dynamic braking situation may for example be detected, when a field technician opens in the power failure situation the hoisting machine brake(s) 116 manually, such that the elevator car 102 starts to move by means of gravity. Alternatively, the dynamic braking situation may for example be detected in case the braking force of the hoisting machine brake(s) 116 is not adequate and the elevator car 102 still moves despite issuing a brake activation command at the end of the elevator journey of the elevator car 102. The dynamic braking situation may also be any other situation outside the normal elevator operation, in which the active dynamic braking may be utilized. The detection of the dynamic braking situation may be detected directly by the elevator drive unit 122 itself or indirectly by obtaining (by the elevator drive unit 122) detection information from any other unit, wherein the detection information indicates a detection of the dynamic braking situation.

At step 320, the elevator drive unit 122 obtains speed data representing the speed of the elevator car 102. More specifically, the drive controller 210 of the elevator drive unit 122 obtains the speed data. The speed data is obtained from the elevator speed measurement system 112, which is configured to provide the speed data as discussed above. The elevator drive unit 122 may obtain the speed data continuously.

At step 340, the elevator drive unit 122 activates the active dynamic braking operation of the elevator system 100 for dynamically braking the movement of the elevator car 102, if the obtained speed data indicates that the speed of the elevator car 102 reaches 330 a predetermined (i.e. preset) monitoring speed level. In other words, the active dynamic braking operation can be activated when the dynamic braking situation is detected, and the obtained speed data indicates that the speed of the elevator car 102 reaches the predetermined monitoring speed level. For example, the predetermined monitoring speed level may be, but is not limited to, 0.20 m/s. The active dynamic braking operation may for example be called as an Active Dynamic Motor Braking (ADMB) operation.

The active dynamic braking operation of the elevator system 100 comprises operating, by the elevator drive unit 122, the motor inverter 240 by switching the high-side switches 250a and the low-side switches 250b of the motor inverter 240 in a controlled manner so that the rotating field is generated in the stator windings of the hoisting motor 230 for braking the rotation of the hoisting motor 230 and thus the movement of the elevator car 102. The drive controller 210 of the elevator drive unit 122 may generate control signals to the high-side and low-side switches 250a, 250b of the motor inverter 240 in order to switch the high-side switches 250a and the low-side switches 250b of the motor inverter 240 during the active dynamic braking operation. With the active dynamic braking operation adequate amount of braking torque can be generated with various hoisting motor models and with various load combinations for dynamically braking the movement of the elevator car 102. The switching the high-side switches 250a and the low-side switches 250b of the motor inverter 240 in the controlled manner may for example comprise switching the high-side switches 250a and the low-side switches 250b such that a sinusoidal rotating field may be generated in the motor windings with a minimal distortion. The switches may be controlled by using any suitable modulation technique. For example, a pulse width modulation (PWM) may be used. However, also any other suitable modulation techniques, such as space vector modulation or any other suitable modulation techniques, may be adopted as well. With said modulation a switching pattern is generated, with a switching frequency being between 5-10 kHz, for example.

During the active dynamic braking operation, the elevator drive unit 122 and the hoisting motor 230 are preferably separated from the mains for safety reasons. The elevator drive unit 122 and the hoisting motor 230 may be separated from the mains for example by means of a contactor, such that the mains power supply may not be used for generating driving torque (i.e. accelerating torque) in the hoisting motor 230. Thus, only braking torque of the hoisting motor 230 may be generated during the active dynamic braking operation. The elevator drive unit 122 may receive its supply voltage from regenerative power of the hoisting motor 230. The drive controller 210 of the elevator drive unit 122 may convert the regenerative power of the hoisting motor 230 to the supply voltage of the elevator drive unit 122. There may for example be a DC/DC converter connected to the DC link 246 of the frequency converter 220 such that it generates a suitable voltage, such as 24V voltage, supply for control electronics of the elevator drive unit 122. The use of the regenerative power of the hoisting motor 230 as the supply voltage of the elevator drive unit 122 enables that no extra backup power supply (e.g. a battery) is required e.g. in case of the power failure situation. Thus, the active dynamic braking operation may be used in various operational conditions and environments (e.g. in power failure situations) without a need for an external power source.

According to an example, a dynamic braking operation (i.e. a traditional dynamic braking operation) may be used in addition to the active dynamic braking operation. In the (traditional) dynamic braking operation, the stator windings of the hoisting motor 230 are shorted to generate the braking torque to dynamically brake the movement of the elevator car 102. The dynamic braking operation may preferably be self-awakening, such that it boots up when a DC link voltage of the elevator drive unit 122 increases when the hoisting motor 230 starts to rotate. The increase of the DC link voltage is caused by an electro motive force (EMF) of the hoisting motor 230, which is rectified from the stator windings of the hoisting motor 230 to the DC link 246 of the elevator drive unit 122 via antiparallel-connected diodes of the motor inverter 240. Preferably, the stator windings of the hoisting motor 230 are shorted as soon as the hoisting motor 230 starts to rotate to dynamically brake the movement of the elevator car 102 already before activation of the active dynamic braking operation. As discussed above, the active dynamic braking operation is activated if the obtained speed data indicates that the speed of the elevator car 102 reaches 330 the predetermined monitoring speed level, but the dynamic braking operation is activated already before the activation of the active dynamic braking operation. This self-awakening dynamic braking operation has been disclosed in the document WO2008/031915 A1.

During the active dynamic braking operation of the elevator system 100, the elevator drive unit 122 may adjust 350 the braking torque generated by the hoisting motor 230 so that the speed of the elevator car 102 does not at least exceed an adaptive speed limit value. The predetermined monitoring speed level is lower than the adaptive speed limit value. An initial value may have been set for the adaptive speed limit value. The initial value of the adaptive speed limit value may for example be, but is not limited to, 0.28 m/s. The adaptive speed limit value may be adapted (e.g. increased) depending on the supply voltage of the elevator drive unit 122 as will be described later in this disclosure. The adjusting the braking torque may comprise operating the high-side switches 250a and the low-side switches 250b of the motor inverter 240. The adjusting of the braking torque may be increasing the braking torque and/or decreasing the braking torque depending on the speed of the elevator car 102. In the permanent magnet motor the motor torque is generated by supplying current in the direction of torque-axis (i.e. q-axis in a dq coordinate system). The q-axis is in practice in orthogonal direction with respect to a magnetization axis (i.e. d-axis), which is in the direction of the permanent magnets. Depending on the polarity of a q-axis current, either the driving torque or the braking torque is generated. The elevator drive unit 122 measures the motor current e.g. by a current control loop, and adjusts by operating the high-side switches 250a and the low-side switches 250b of the motor inverter 240 the supply voltage in the motor windings to control the q-axis current and thus also the braking torque.

As discussed above, during the active dynamic braking operation of the elevator system 100 the elevator drive unit 122 may adjust the braking torque in the hoisting motor 230 so that the speed of the elevator car 102 does not at least exceed the adaptive speed limit value. However, there may exist situations, where the present adaptive speed limit value is not adequate (i.e. sufficient) to energize the elevator drive unit 122. For example, when the regenerative power of the hoisting motor 230 is not enough to supply adequate supply voltage to the elevator drive unit 122 anymore. If the adaptive speed limit value is not adequate to energize the elevator drive unit, the active dynamic braking would stop working. Therefore, to maintain the active dynamic braking operation, the adaptive speed limit value may need to be adapted (e.g. increased). In other words, during the active dynamic braking operation, the speed of the elevator car 102 may be limited adaptively to energize the elevator drive unit 122 adequately. The adaptive speed limitation for the active dynamic braking operation enables that it may be ensured that the hoisting motor 230 generates enough power (i.e. regenerative power) to keep the elevator drive unit 122 in operation in order to be able to maintain the active dynamic braking operation to dynamically brake the movement of the elevator car 102.

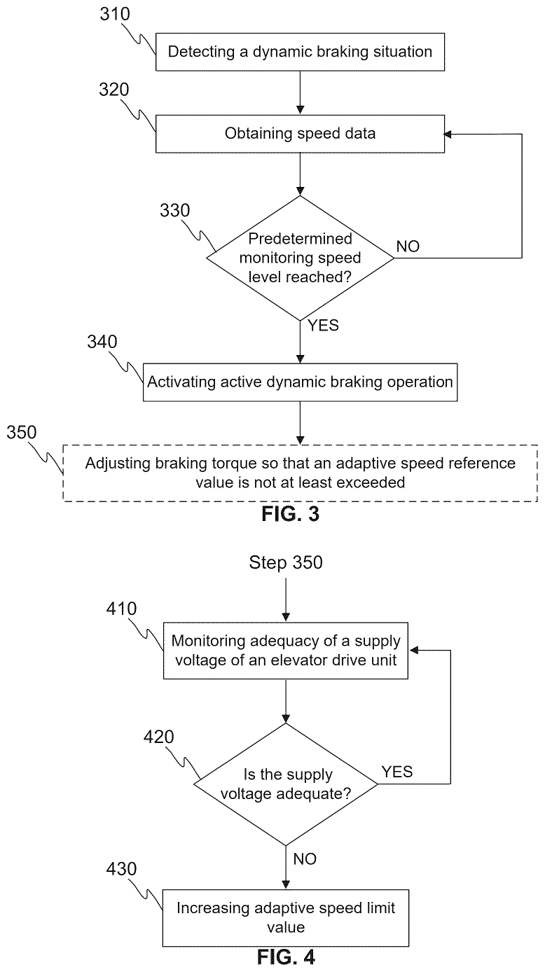

The adaptive speed limitation for the active dynamic braking operation is discussed next by referring to FIG. 4, which illustrates schematically the adaptive speed limitation as a flow chart

At step 410, the elevator drive unit 122 may monitor the adequacy of the supply voltage of the elevator drive unit 122 to energize the elevator drive unit 122. In other words, the elevator drive unit 122 monitor whether the supply voltage of the elevator drive unit 122 with the speed of the elevator car 102 following the present level of the adaptive speed limit value is adequate to energize the elevator drive unit 122. For example, the adequacy of the supply voltage may be monitored by monitoring the adequacy of the regenerated motor power. Alternatively or in addition, the adequacy of the supply voltage may for example be monitored by monitoring the DC link voltage of the drive unit 122. According to a non-limiting example, the predetermined voltage limit value may be 300 VDC. Alternatively or in addition, the monitoring of the adequacy of the supply voltage of the elevator drive unit 122 may for example comprise monitoring a magnetization-axis current (la) of the hoisting motor 230.

If the monitoring of the adequacy of the supply voltage of the elevator drive unit 122 indicates 420 that the present level of the adaptive speed limit value is not adequate to energize the elevator drive unit 122, the elevator drive unit 122 increases 430 the adaptive speed limit value. In other words, it is detected that the speed of the elevator car 102 needs to be higher than the present adaptive speed limit value in order to energize the elevator drive unit 122 adequately by the supply voltage of the elevator drive unit 122 (i.e. the regenerative power of the hoisting motor 230). The increase of the adaptive speed limit enables an increase of the supply voltage of the elevator drive unit 122, which in turn enables maintaining adequate energizing of the elevator drive unit 122 and thus also maintaining the active dynamic braking operation. For example, in case the regenerative motor power is monitored, the adaptive speed limit value may be increased, if the regenerative motor power drops below a minimum power limit. In other words, the regenerative motor power is monitored and if the monitored regenerative motor power drops below the minimum power limit, the adaptive speed limit value is increased. According to another example, in case the DC link voltage of the drive unit 112 is monitored, the adaptive speed limit value may be increased, if the DC link voltage of the drive unit 122 drops below a minimum voltage limit. In other words, the DC link voltage is monitored and if the monitored DC link voltage drops below the minimum voltage limit, the adaptive speed limit value is increased. According to yet another example, in case the magnetization-axis current is monitored, the adaptive speed limit value may be increased, if the monitored magnetization-axis current falls below a minimum current limit. In other words, the magnetization-axis current of the hoisting motor 230 is monitored and if the monitored magnetization-axis current falls below the minimum current limit, the adaptive speed limit value is increased.

The adaptive speed limit value is preferably below a buffer impact speed. Thus, the use of the active dynamic braking operation ensures that in the inadequate braking force situation upon issuing the hoisting machine brake activation command the speed of the elevator car 102 cannot exceed the buffer impact speed. Thus, the active dynamic braking operation may also act as a solution to fulfill other braking means (OBM) safety requirement.

Next non-limiting example equations for defining the adaptive speed limit are presented. The motor torque T_{M} may be defined by the following equation:

$${T}_{M} [ Nm ] = \frac{{P}_{mech}}{{ω}_{mech}} ,$$

wherein P_{mech} is a motor nominal mechanical power and ω_{mech} is a mechanical angular speed of the motor. The mechanical angular speed may be defined by the following equation:

$${ω}_{mech} [ rad / s ] = \frac{2 π \times RPM}{60} ,$$

wherein RPM is a motor nominal speed in RPM.

Next motor power losses P_{M} may be defined by the following equation:

$${P}_{M} [ W ] = 3 \times {r}_{s} \times {I}_{M}^{2} ,$$

wherein rₛ is a motor stator resistance and I_{M} is a motor nominal current.

The total losses P_{TOT} may then be defined by the following equation:

$${P}_{TOT} [ W ] = {P}_{M} + {P}_{D} ,$$

wherein P_{D} represents estimated losses of the drive unit 122.

A minimum angular speed ωₘᵢₙ in the active dynamic braking operation may be defined by using the following equation:

$${ω}_{min} [ rad / s ] = \frac{{P}_{TOT}}{max ( {T}_{N} , {T}_{M} )} .$$

wherein T_{N} is a motor nominal torque.

A minimum value for the adaptive speed limit νₘᵢₙ may be defined for example by using the following equation:

$${v}_{min} [ m / s ] = \frac{{ω}_{min} \times {D}_{ts}}{2 \times roping} ,$$

wherein Dₜₛ is a diameter of the traction sheave 114 and roping is a roping ratio of the elevator hoisting roping arrangement 118 (e.g. 1, 2, 4, etc.). The adaptive speed limit needs to have at least the minimum value νₘᵢₙ to keep the elevator drive unit 122 in operation during the active dynamic braking operation.

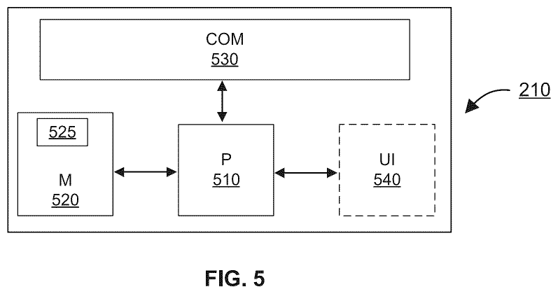

FIG. 5 illustrates a schematic example of components of the drive controller 210 of the elevator drive unit 122. The drive controller 210 may be a separate unit or may be comprised in or as a part of other units, e.g. the frequency converter 220 and/or the drive controller 210 may be comprised in or as a part of the elevator control unit 110. The drive controller 210 may also be arranged in distributed manner at more than two locations or in more than two units. The drive controller 210 may comprise one or more processors 510, one or more memories 520 being volatile or non-volatile for storing portions of computer program code 525 and any data values, one or more communication interface units 530 and possibly one or more user interface units 540. The mentioned elements may be communicatively coupled to each other with e.g. an internal bus. The processor 510 may be configured to execute at least some portion of a computer program code 525 stored in the memory 520 causing the processor 510, and thus the drive controller 210, to perform desired tasks, e.g. the operations of the drive controller 210 and/or the method steps described above. The processor 510 may thus be arranged to access the memory 520 and retrieve and store any information therefrom and thereto. For sake of clarity, the processor herein refers to any unit suitable for processing information and control the operation of the drive controller 210, among other tasks. The operations may also be implemented with a microcontroller solution with embedded software. Similarly, the memory 520 is not limited to a certain type of memory only, but any memory type suitable for storing the described pieces of information may be applied in the context of the present invention.

The communication interface unit 530 provides an interface for communication with any external unit, e.g. the elevator car speed measurement system 112, the elevator control unit 110, one or more databases, and/or with any other unit. The communication interface unit may be based on one or more known communication technologies, either wired or wireless, in order to exchange pieces of information. The one or more user interface units 540 may comprise one or more input/output (I/O) devices, such as buttons, keyboard, touch screen, microphone, loudspeaker, display and so on, for receiving input and outputting information. The computer program 525 may be a computer program product that may be comprised in a tangible non-volatile (non-transitory) computer-readable medium bearing the computer program code 525 embodied therein for use with a computer, i.e. the drive controller 210 of the elevator drive unit 122.

The specific examples provided in the description given above should not be construed as limiting the applicability and/or the interpretation of the appended claims. Lists and groups of examples provided in the description given above are not exhaustive unless otherwise explicitly stated.

1. A method for active dynamic braking of an elevator system, the method comprising:
detecting a dynamic braking situation,
obtaining speed data representing a speed of an elevator car, and
activating an active dynamic braking operation for dynamically braking the movement of the elevator car, if the obtained speed data indicates that the speed of the elevator car reaches a predetermined monitoring speed level,
wherein the active dynamic braking operation comprises operating a motor inverter of an elevator drive unit of the elevator system by switching high-side switches and low-side switches of the motor inverter in a controlled manner so that a rotating field is generated in stator windings of a hoisting motor for dynamically braking the rotation of the hoisting motor and thus the movement of the elevator car.

2. The method according to claim 1 further comprising adjusting a braking torque generated by the hoisting motor so that the speed of the elevator car does not at least exceed an adaptive speed limit value during the active dynamic braking operation, wherein the predetermined monitoring speed level is lower than the adaptive speed limit value.

3. The method according to claim 2 further comprising:
monitoring adequacy of a supply voltage of the elevator drive unit to energize the elevator drive unit, wherein the supply voltage of the elevator drive unit is regenerated from the hoisting motor; and
increasing the adaptive speed limit value, if the monitoring of the adequacy of the supply voltage of the elevator drive unit indicates that the present level of the adaptive speed limit value is not adequate to energize the elevator drive unit.

4. The method according to claim 3, wherein monitoring the adequacy of the supply voltage of the elevator drive unit comprises monitoring at least one of the following:
adequacy of the regenerated motor power, and wherein the adaptive speed limit value is increased, if regenerated motor power drops below a minimum power limit;
a DC link voltage of the drive unit, and wherein the adaptive speed limit value is increased, if the DC link voltage of the drive unit drops below a minimum voltage limit;
a magnetization-axis current of the hoisting motor, and wherein the adaptive speed limit value is increased, if the magnetization-axis current falls below a minimum current limit.

5. The method according to claim 2, wherein adjusting the braking torque generated by the hoisting motor comprises operating the high-side switches and the low-side switches of the motor inverter.

6. The method according to claim 1, wherein the dynamic braking situation is one of the following: a manual opening of a hoisting machine brake due to a power failure situation; an inadequate braking force situation upon issuing a hoisting machine brake activation command.

7. An elevator drive unit of an elevator system, wherein the elevator drive unit comprises:
a motor inverter connected to stator windings of a hoisting motor of the elevator system, wherein the motor inverter has high-side switches and low-side switches; and
a drive controller;
wherein the drive controller of the elevator drive unit is configured to cause the elevator drive unit to perform:
detect a dynamic braking situation,
obtain speed data representing a speed of an elevator car, and
activate an active dynamic braking operation for dynamically braking the movement of the elevator car, if the obtained speed data indicates that the speed of the elevator car reaches a predetermined monitoring speed level, wherein the active dynamic braking operation comprises that the drive controller is configured to operate the motor inverter by switching the high-side switches and the low-side switches of the motor inverter in a controlled manner so that the rotating field is generated in the stator windings of the hoisting motor for dynamically braking the rotation of the hoisting motor and thus the movement of the elevator car.

8. The elevator drive unit according to claim 7, further configured to adjust a braking torque generated by the hoisting motor so that the speed of the elevator car does not at least exceed an adaptive speed limit value during the active dynamic braking operation, wherein the predetermined monitoring speed level is lower than the adaptive speed limit value.

9. The elevator drive unit according to claim 8, further configured to:
monitor adequacy of a supply voltage of the elevator drive unit to energize the elevator drive unit, wherein the supply voltage of the elevator drive unit is regenerated from the hoisting motor; and
increase the adaptive speed limit value, if the monitoring of the adequacy of the supply voltage of the elevator drive unit indicates that the present level of the adaptive speed limit value is not adequate to energize the elevator drive unit.

10. The elevator drive unit according to claim 9, wherein to monitor the adequacy of the supply voltage of the elevator drive unit the elevator drive unit is configured to monitor at least one of the following:
adequacy of the regenerated motor power, and wherein the elevator drive unit is configured to increase the adaptive speed limit value, if the regenerated motor power drops below a minimum power limit;
a DC link voltage of the drive unit, and wherein the elevator drive unit is configured to increase the adaptive speed limit value, if the DC link voltage of the drive unit drops below a minimum voltage limit;
a magnetization-axis current of the hoisting motor, and wherein the elevator drive unit is configured to increase the adaptive speed limit value, if the magnetization-axis current falls below a minimum current limit.

11. The elevator drive unit according to claim 8, wherein the elevator drive unit is configured to operate the high-side switches and low-side switches of the motor inverter to adjust the braking torque.

12. The elevator drive unit according to claim 7, wherein the dynamic braking situation is one of the following: a manual opening of a hoisting machine brake due to a power failure situation; an inadequate braking force situation upon issuing a hoisting machine brake activation command.

13. An elevator system comprising:
an elevator hoisting machine comprising a hoisting motor,
an elevator car configured to travel along an elevator shaft,
an elevator car speed measurement system configured to provide speed data representing a speed of the elevator car, and
an elevator drive unit according to claim 7.

14. A computer program comprising instructions which, when the program is executed by a computer, cause the computer to carry out the method according to claim 1.

15. A computer-readable storage medium comprising instructions which, when executed by a computer, cause the computer to carry out the method according to claim 1.
